(19) United States
(12) Patent Application Publication
(10) Pub. No.: US 2023/0063555 A1
(43) Pub. Date: Mar. 2, 2023

(54) CONTROL DEVICE, CONTROL METHOD, AND NON-TRANSITORY STORAGE MEDIUM

(71) Applicant: TOYOTA JIDOSHA KABUSHIKI KAISHA, Toyota-shi (JP)

(72) Inventors: Junichiro TAMAO, Nagoya-shi (JP); Tetsuro NAKAMURA, Nagoya-shi (JP)

(21) Appl. No.: 17/819,725

(22) Filed: Aug. 15, 2022

(30) Foreign Application Priority Data
Sep. 1, 2021 (JP) 2021-142250

(51) Int. Cl. H02J 3/32

(52) U.S. Cl. CPC H02J 3/32; H02J 2300/24

(57) ABSTRACT

A control device includes a processor configured to detect a voltage at an intermediate point connecting a first DCDC converter and a second DCDC converter, control the first DCDC converter and the second DCDC converter, and when the detected voltage at the intermediate point exceeds a first threshold, limit an output of the first DCDC converter after an output current of the second DCDC converter reaches a predetermined value.

### CROSS-REFERENCE TO RELATED APPLICATION

This application claims priority to Japanese Patent Application No. 2021-142250 filed on Sep. 1, 2021, incorporated herein by reference in its entirety.

### BACKGROUND

### 1. Technical Field

The present disclosure relates to a control device, a control method, and a non-transitory storage medium. The control device is configured to control, for example, a solar charging system that charges a battery by using electric power generated by a solar panel.

### 2. Description of Related Art

Japanese Unexamined Patent Application Publication No. 2021-087291 (JP 2021-087291 A) discloses a solar charging system including two solar panels, two solar direct current/direct current (DCDC) converters provided in association with the respective solar panels, a high-voltage DCDC converter that supplies output power of the solar DCDC converters to a high-voltage battery, and an auxiliary DCDC converter that supplies the output power of the solar DCDC converters to an auxiliary battery.

### SUMMARY

In the system including the plurality of DCDC converters in JP 2021-087291 A, there is a possibility that a voltage at an intermediate point connecting an output side of each solar DCDC converter and an input side of each of the high-voltage DCDC converter and the auxiliary DCDC converter increases over a predetermined value due to, for example, a fluctuation in the electric power generated by the solar panel. This phenomenon is called “overvoltage at the intermediate point”. The overvoltage at the intermediate point affects deterioration and failure in circuit elements constituting the system. Therefore, it is necessary to protect the circuit elements in the event of the overvoltage at the intermediate point.

The present disclosure provides a control device, a control method, and a non-transitory storage medium that can appropriately protect circuit elements and the like in a solar charging system in the event of an overvoltage at an intermediate point.

A first aspect of the present disclosure is a control device including a processor. The control device is configured to detect a voltage at an intermediate point connecting a first DCDC converter and a second DCDC converter, control the first DCDC converter and the second DCDC converter, and when the detected voltage at the intermediate point exceeds a first threshold, limit an output of the first DCDC converter after an output current of the second DCDC converter reaches a predetermined value. The processor is configured to control a charging system including a solar unit and a power conversion unit. The solar unit includes a solar panel and the first DCDC converter. The power conversion unit includes the second DCDC converter and a rechargeable battery connected to the second DCDC converter. Electric power generated by the solar panel is configured to be input to the first DCDC converter, and electric power output by the solar unit is configured to be input to the second DCDC converter.

In the first aspect, the charging system may include two solar units as the solar unit, or two power conversion units as the power conversion unit.

In the first aspect, the processor may be configured to cause the output current of the second DCDC converter to reach a second threshold or smaller after limiting the output of the first DCDC converter.

In the first aspect, the charging system may include two power conversion units as the power conversion unit. The processor may be configured to limit an output of the second DCDC converter included in one of the two power conversion units when the detected voltage at the intermediate point exceeds the first threshold, and limit the output of the first DCDC converter after the output current of the second DCDC converter included in the other of the two power conversion units reaches the predetermined value.

In the first aspect, the predetermined value of the output current of the second DCDC converter may be a maximum value.

In the first aspect, the processor may be configured to limit the output of the first DCDC converter and an output of the second DCDC converter by stopping the outputs.

A second aspect of the present disclosure is a control method for a control device configured to control a charging system including a solar unit including a solar panel and a first DCDC converter, and a power conversion unit including a second DCDC converter and a rechargeable battery connected to the second DCDC converter. The control method includes detecting a voltage at an intermediate point where the first DCDC converter is connected to the second DCDC converter, electric power generated by the solar panel is configured to be input to the first DCDC converter, and electric power output by the solar unit is configured to be input to the second DCDC converter, controlling, an output current of the second DCDC converter to reach a predetermined value when the detected voltage at the intermediate point exceeds a first threshold, and limiting an output of the first DCDC converter after the output current of the second DCDC converter is controlled to reach the predetermined value.

In the second aspect, the charging system may include two solar unit as the solar unit, or two power conversion unit as the power conversion unit.

A third aspect of the present disclosure is a non-transitory storage medium storing instructions that are executable by one or more processors in a computer of a control device and that cause the one or more processors to perform functions. The control device is configured to control a charging system including a solar unit including a solar panel and a first DCDC converter, and a power conversion unit including a second DCDC converter and a rechargeable battery connected to the second DCDC converter. The functions include detecting a voltage at an intermediate point where the first DCDC converter is connected to the second DCDC converter, electric power generated by the solar panel is configured to be input to the first DCDC converter, and electric power output by the solar unit is input to the second DCDC converter, controlling an output current of the second DCDC converter to reach a predetermined value when the detected voltage at the intermediate point exceeds a first threshold, and limiting an output of the first DCDC converter after the output current of the second DCDC converter is controlled to reach the predetermined value.

In the third aspect, the charging system may include two solar unit as the solar unit, or two power conversion unit as the power conversion unit.

According to the first aspect, the second aspect, and the third aspect of the present disclosure, it is possible to appropriately protect the circuit elements and the like in the solar charging system by controlling the DCDC converters in the event of the overvoltage at the intermediate point.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a solar charging system including a solar control device according to an embodiment;

FIG. 2 is a flowchart of a charging control process (first example) to be executed by the solar control device;

FIG. 3 is a flowchart of an applied example of the charging control process (first example) to be executed by the solar control device;

FIG. 4 is a flowchart of a charging control process (second example) to be executed by the solar control device;

FIG. 5 is a flowchart of an applied example of the charging control process (second example) to be executed by the solar control device; and

FIG. 6 is a diagram showing a processing timing example of each DCDC converter in the charging control process of the first example.

### DETAILED DESCRIPTION OF EMBODIMENTS

In a solar control device according to the present disclosure, when a voltage at an intermediate point connecting a solar unit and a power conversion unit is an overvoltage, the output of the solar unit is stopped after establishing a path for releasing electric charge at the intermediate point by the power conversion unit. As a result, a direct current/direct current (DCDC) converter is stopped in a state in which the voltage at the intermediate point is reduced to a safe level. Thus, circuit elements and the like in the system can be protected appropriately. Hereinafter, one embodiment of the present disclosure will be described in detail with reference to the drawings.

### EMBODIMENT

### Configuration

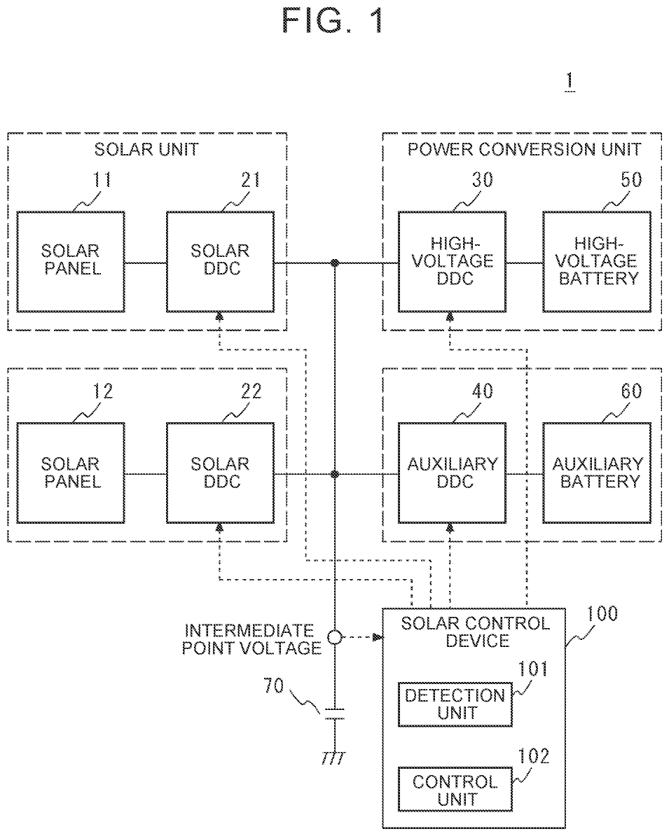

FIG. 1 is a block diagram showing a schematic configuration of a solar charging system including a solar control device according to one embodiment of the present disclosure. A solar charging system 1 illustrated in FIG. 1 includes two solar panels 11 and 12, two solar DDCs 21 and 22, a high-voltage DDC 30, an auxiliary DDC 40, a high-voltage battery 50, an auxiliary battery 60, a capacitor 70, and a solar control device 100 of the present embodiment. In FIG. 1, a continuous line represents a connection line through which electric power is transmitted and received, and a dashed line represents a connection line through which instructions and data are communicated. This solar charging system 1 can be mounted on a vehicle or the like.

The solar panels 11 and 12 are power generation devices that generate electric power by being irradiated with sunlight, and are typically solar cell modules that are an aggregate of solar cells. The solar panels 11 and 12 can be installed, for example, on the roof of a vehicle. The one solar panel 11 is connected to the one solar DDC 21 described later, and the electric power generated by the solar panel 11 is output to the solar DDC 21. The other solar panel 12 is connected to the other solar DDC 22 described later, and the electric power generated by the solar panel 12 is output to the solar DDC 22. The solar panel 11 and the solar panel 12 may have totally the same performance, capacity, size, and shape, or may partially or totally be different from each other.

The solar DDCs 21 and 22 are direct current/direct current converters (first DCDC converters) that are provided in association with the respective solar panels 11 and 12 and supply the electric power generated by the solar panels 11 and 12 to the high-voltage DDC 30 and the auxiliary DDC 40. At the time of power supply, the solar DDC 21 can convert (step up or down), into a predetermined voltage, a voltage of the electric power generated by the solar panel 11 that is an input voltage, and output the voltage to the high-voltage DDC 30 and the auxiliary DDC 40. At the time of power supply, the solar DDC 22 can convert (step up or down), into a predetermined voltage, a voltage of the electric power generated by the solar panel 12 that is an input voltage, and output the voltage to the high-voltage DDC 30 and the auxiliary DDC 40. The structures and performances of the solar DDCs 21 and 22 may be the same or may be different depending on the solar panels 11 and 12.

Among the solar panels 11 and 12 and the solar DDCs 21 and 22, the solar panel 11 and the solar DDC 21 constitute one solar unit, and the solar panel 12 and the solar DDC 22 constitute another solar unit. The solar charging system 1 of the present embodiment has an exemplary configuration in which the two solar units are provided in parallel, but may have a configuration in which one solar unit is provided alone or a configuration in which three or more solar units are provided in parallel.

The high-voltage DDC 30 is a direct current/direct current converter (second DCDC converter) that supplies the electric power output by the solar DDCs 21 and 22 to the high-voltage battery 50. At the time of power supply, the high-voltage DDC 30 can convert (step up), into a predetermined voltage, the output voltage of the solar DDCs 21 and 22 that is an input voltage, and output the voltage to the high-voltage battery 50.

The auxiliary DDC 40 is a DCDC converter (second DCDC converter) that supplies the electric power output by the solar DDCs 21 and 22 to the auxiliary battery 60. At the time of power supply, the auxiliary DDC 40 can convert (step down), into a predetermined voltage, the output voltage of the solar DDCs 21 and 22 that is an input voltage, and output the voltage to the auxiliary battery 60.

The high-voltage battery 50 is a chargeable and dischargeable secondary battery such as a lithium ion battery or a nickel-metal hydride battery. The high-voltage battery 50 is connected to the high-voltage DDC 30 so that the high-voltage battery 50 is chargeable with the electric power output by the high-voltage DDC 30. Examples of the high-voltage battery 50 mounted on the vehicle include a so-called driving battery that can supply electric power necessary for operating main devices (not shown) for driving the vehicle, such as a starter motor and an electric motor.

The auxiliary battery 60 is a chargeable and dischargeable secondary battery such as a lithium ion battery or a lead storage battery. The auxiliary battery 60 is connected to the auxiliary DDC 40 so that the auxiliary battery 60 is chargeable with the electric power output by the auxiliary DDC 40. The auxiliary battery 60 mounted on the vehicle is a battery that can supply electric power necessary for operating auxiliary devices (not shown) other than the devices for driving the vehicle, such as lights typified by head lamps and interior lights, air conditioners typified by a heater and a cooler, and devices for autonomous driving and advanced driver assistance.

Among the high-voltage DDC 30, the auxiliary DDC 40, the high-voltage battery 50, and the auxiliary battery 60, the high-voltage DDC 30 and the high-voltage battery 50 constitute one power conversion unit, and the auxiliary DDC 40 and the auxiliary battery 60 constitute another power conversion unit. The solar charging system 1 of the present embodiment has an exemplary configuration in which the two power conversion units are provided in parallel, but may have a configuration in which one power conversion unit (for example, the power conversion unit constituted by the auxiliary DDC 40 and the auxiliary battery 60) is provided alone in a case where a plurality of the solar units is provided in parallel. Alternatively, three or more power conversion units may be provided in parallel. That is, the technology of the present disclosure is useful in a case where the solar charging system 1 includes a plurality of units as at least one of the solar unit and the power conversion unit.

The capacitor 70 is connected between each of the solar DDCs 21 and 22 and each of the high-voltage DDC 30 and the auxiliary DDC 40. The capacitor 70 is a large-capacity capacitive element to be used to store or discharge the electric power generated by the solar panels 11 and 12 as needed and to stabilize a voltage at a connection point where the outputs of the solar DDC 21 and the solar DDC 22 are connected to the inputs of the high-voltage DDC 30 and the auxiliary DDC 40 (hereinafter referred to as “intermediate point”).

The solar control device 100 is responsible for at least a part of control to be executed by the solar charging system 1. The solar control device 100 includes a detection unit 101 and a control unit 102.

The detection unit 101 detects the voltage at the intermediate point where the solar DDC 21 and the solar DDC 22 are connected to the high-voltage DDC 30 and the auxiliary DDC 40. For example, a voltage sensor in the DDC is used to detect the intermediate point voltage. The control unit 102 controls at least the solar DDC 21 and the solar DDC 22 and further controls the high-voltage DDC 30 and the auxiliary DDC 40 to protect circuit elements and the like in the solar charging system 1 based on a result of the intermediate point voltage detected by the detection unit 101. The control unit 102 of the present embodiment performs control for protecting the circuit elements and the like constituting the solar charging system 1 when detecting that the intermediate point voltage detected by the detection unit 101 is an overvoltage exceeding a predetermined threshold. Details of processes to be performed by the detection unit 101 and the control unit 102 will be described later.

A part or all of the solar DDCs 21 and 22, the high-voltage DDC 30, the auxiliary DDC 40, and the solar control device 100 may typically be provided as an electronic control unit (ECU) including a processor, a memory, an input/output interface, and the like. The electronic control unit can perform various types of control described above by reading and executing a program stored in the memory by the processor.

### Control

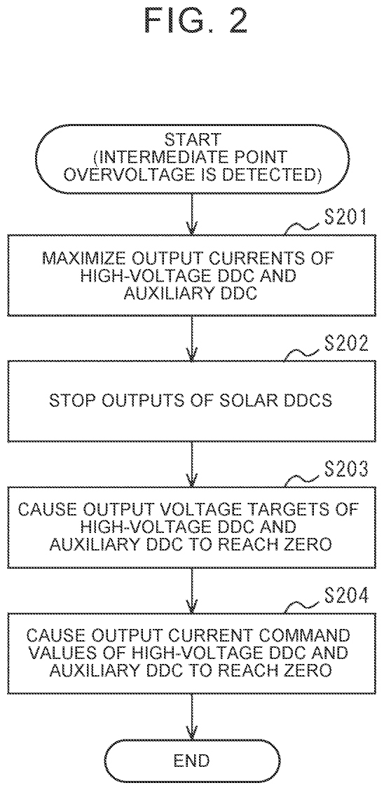

Next, several examples of a control process to be executed by the solar control device 100 will be described with reference to FIGS. 2 to 5. Each process described below is started in response to detection that the intermediate point voltage is an overvoltage exceeding a predetermined value (hereinafter referred to as “first threshold”). The first threshold is a predetermined value arbitrarily set based on a voltage value that may affect deterioration and failure in the circuit elements constituting the solar charging system 1 when the intermediate point voltage reaches that value.

### First Example

FIG. 2 is a flowchart illustrating a first example of a charging control process to be executed by the solar control device 100. In the charging control process of the first example shown in FIG. 2, the same process is performed on the high-voltage DDC 30 and the auxiliary DDC 40 in the respective power conversion units.

### Step S201

The solar control device 100 causes a current output from the high-voltage DDC 30 to the high-voltage battery 50 to reach a predetermined value, and a current output from the auxiliary DDC 40 to the auxiliary battery 60 to reach a predetermined value. Each predetermined value is desirably the maximum value. More specifically, when the intermediate point voltage on the input side is an overvoltage, the high-voltage DDC 30 and the auxiliary DDC 40 perform feedback control to gradually increase the output current and reduce the voltage on the input side. If the overvoltage state is not resolved by the control, the output current from each of the high-voltage DDC 30 and the auxiliary DDC 40 finally reaches the maximum value that is the upper limit. Therefore, the solar control device 100 waits until the high-voltage DDC 30 and the auxiliary DDC 40 are controlled so that the output current reaches the maximum value. When the current output from the high-voltage DDC 30 to the high-voltage battery 50 reaches the maximum (predetermined value) and the current output from the auxiliary DDC 40 to the auxiliary battery 60 reaches the maximum (predetermined value), the process proceeds to Step S202.

### Step S202

The solar control device 100 limits the outputs of the solar DDC 21 and the solar DDC 22. The limitation on the outputs is desirably a stop of the outputs. The outputs may be stopped by instructing the solar DDC 21 and the solar DDC 22 based on a command value for causing the output currents to reach zero, or by stopping the power supply to the solar DDC 21 and the solar DDC 22. By stopping the outputs of the solar DDC 21 and the solar DDC 22 and maximizing the output currents of the high-voltage DDC 30 and the auxiliary DDC 40, the electric charge stored in the capacitor 70 is released to the high-voltage battery 50 and the auxiliary battery 60. When the outputs of the solar DDC 21 and the solar DDC 22 are stopped (limited), the process proceeds to Step S203.

### Step S203

The solar control device 100 causes an output voltage target of the high-voltage DDC 30 to reach zero, and an output voltage target of the auxiliary DDC 40 to reach zero. More specifically, when the outputs of the solar DDC 21 and the solar DDC 22 are stopped, the electric charge in the capacitor 70 is gradually released and there is finally no electric power to charge the high-voltage battery 50 and the auxiliary battery 60 from the high-voltage DDC 30 and the auxiliary DDC 40, respectively. Therefore, both the output voltage target of the high-voltage DDC 30 and the output voltage target of the auxiliary DDC 40 are controlled at zero. When the output voltage target of the high-voltage DDC 30 reaches zero and the output voltage target of the auxiliary DDC 40 reaches zero, the process proceeds to Step S204.

The zero check on the output voltage targets for the high-voltage battery 50 and the auxiliary battery 60 in the process of Step S203 may be omitted.

### Step S204

The solar control device 100 causes an output current command value of the high-voltage DDC 30 to reach a predetermined value (hereinafter referred to as “second threshold”), and an output current command value of the auxiliary DDC 40 to reach a predetermined value. This process is performed to stop the operations of the high-voltage DDC 30 and the auxiliary DDC 40 after the electric charge in the capacitor 70 is depleted. Therefore, the second threshold is typically zero. When the output current command value of the high-voltage DDC 30 reaches zero (second threshold) and the output current command value of the auxiliary DDC 40 reaches zero (second threshold), the charging control process of the first example is terminated.

As in the charging control process of the first example, the outputs of the solar DDC 21 and the solar DDC 22 are stopped after securing a path for releasing the overvoltage charge stored in the capacitor 70 connected to the intermediate point by the power conversion unit constituted by the high-voltage DDC 30 and the high-voltage battery 50 and the power conversion unit constituted by the auxiliary DDC 40 and the auxiliary battery 60. As a result, all of the solar DDC 21, the solar DDC 22, the high-voltage DDC 30, and the auxiliary DDC 40 can be stopped in a state in which the intermediate point voltage is reduced to a safe level. Thus, the circuit elements and the like in the solar charging system 1 can appropriately be protected from deterioration and failure.

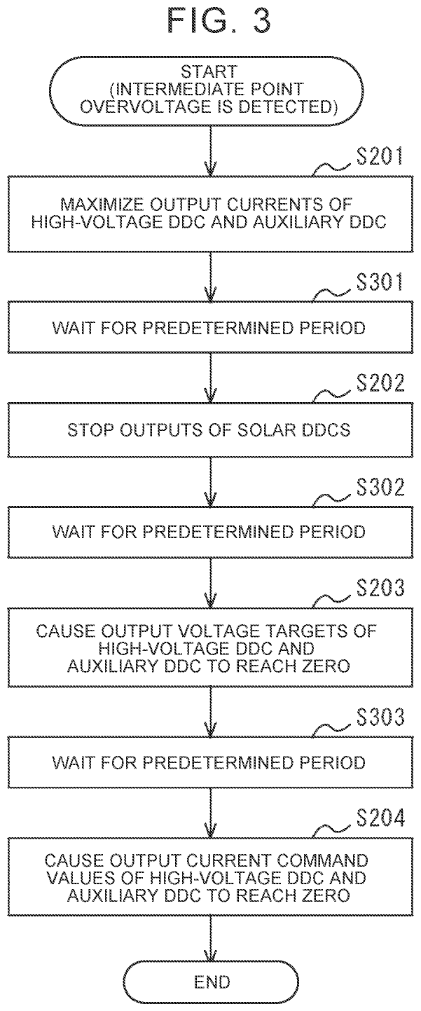

When there is a possibility that the order of the processes from Step S201 to Step S204 is changed due to, for example, the compilation speed of the processing program or the control response of the circuit elements, a predetermined period to wait for execution (Steps S301, S302, and S303) may be provided between the processing steps as shown in an applied example of FIG. 3. Examples of the predetermined waiting period include one cycle of a system clock.

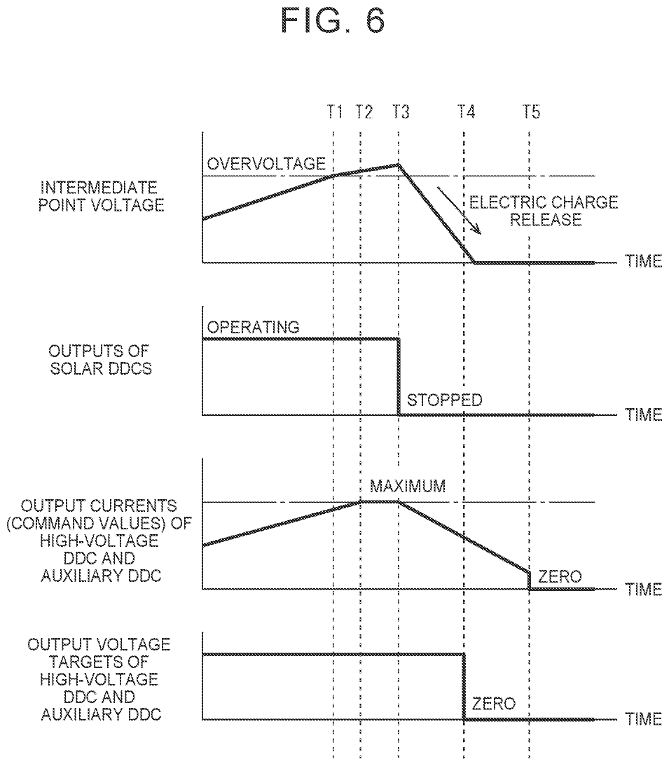

FIG. 6 shows an example of processing timings of the solar DDC 21, the solar DDC 22, the high-voltage DDC 30, and the auxiliary DDC 40 in the charging control process of the first example. In the example of FIG. 6, after detection is made that the intermediate point voltage is an overvoltage (T1), the output current of the high-voltage DDC 30 and the output current of the auxiliary DDC 40 are maximized in an attempt to reduce the intermediate point voltage (T2). Then, the outputs of the solar DDC 21 and the solar DDC 22 are stopped to stop the power supply to the intermediate point (T3). As a result, the voltage at the intermediate point decreases because the electric charge in the capacitor 70 is only released, and the output voltage targets of the high-voltage DDC 30 and the auxiliary DDC 40 are controlled at zero (T4). Finally, the output currents of the high-voltage DDC 30 and the auxiliary DDC 40 are set to zero to stop the DDC operations (T5).

### Second Example

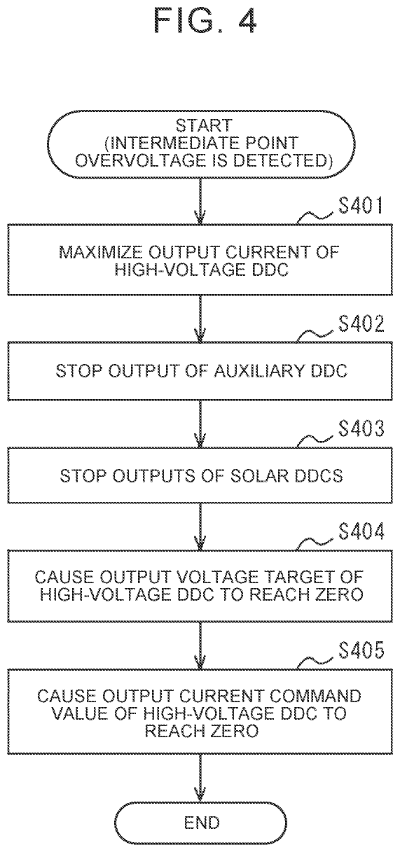

FIG. 4 is a flowchart illustrating a second example of the charging control process to be executed by the solar control device 100. In the charging control process of the second example shown in FIG. 4, different processes are performed on the high-voltage DDC 30 and the auxiliary DDC 40 in the respective power conversion units.

### Step S401

The solar control device 100 causes the current output from the high-voltage DDC 30 to the high-voltage battery 50 to reach a predetermined value. The predetermined value is desirably the maximum value. More specifically, when the intermediate point voltage on the input side is an overvoltage, the high-voltage DDC 30 performs feedback control to gradually increase the output current and reduce the voltage on the input side. If the overvoltage state is not resolved by the control, the output current from the high-voltage DDC 30 finally reaches the maximum value that is the upper limit. Therefore, the solar control device 100 waits until the high-voltage DDC 30 is controlled so that the output current reaches the maximum value. When the current output from the high-voltage DDC 30 to the high-voltage battery 50 reaches the maximum (predetermined value), the process proceeds to Step S402.

### Step S402

The solar control device 100 limits the output of the auxiliary DDC 40. The limitation on the output is desirably a stop of the output. The output may be stopped by instructing the auxiliary DDC 40 based on a command value for causing the output current to reach zero, or by stopping the power supply to the auxiliary DDC 40. When the output of the auxiliary DDC 40 is stopped (limited), the process proceeds to Step S403.

### Step S403

The solar control device 100 limits the outputs of the solar DDC 21 and the solar DDC 22. The limitation on the outputs is desirably a stop of the outputs. The outputs may be stopped by instructing the solar DDC 21 and the solar DDC 22 based on a command value for causing the output currents to reach zero, or by stopping the power supply to the solar DDC 21 and the solar DDC 22. By stopping the outputs of the solar DDC 21 and the solar DDC 22, stopping the output of the auxiliary DDC 40, and maximizing the output current of the high-voltage DDC 30, the electric charge stored in the capacitor 70 is released to the high-voltage battery 50. When the outputs of the solar DDC 21 and the solar DDC 22 are stopped (limited), the process proceeds to Step S404.

### Step S404

The solar control device 100 causes the output voltage target of the high-voltage DDC 30 to reach zero. More specifically, when the outputs of the solar DDC 21 and the solar DDC 22 are stopped, the electric charge in the capacitor 70 is gradually released and there is finally no electric power to charge the high-voltage battery 50 from the high-voltage DDC 30. Therefore, the output voltage target of the high-voltage DDC 30 is controlled at zero. When the output voltage target of the high-voltage DDC 30 reaches zero, the process proceeds to Step S405.

The zero check on the output voltage target for the high-voltage battery 50 in the process of Step S404 may be omitted.

### Step S405

The solar control device 100 causes the output current command value of the high-voltage DDC 30 to reach a predetermined value (second threshold). This process is performed to stop the operation of the high-voltage DDC 30 after the electric charge in the capacitor 70 is depleted. Therefore, the second threshold is typically zero. When the output current command value of the high-voltage DDC 30 reaches zero (second threshold), the charging control process of the second example is terminated.

As in the charging control process of the second example, the outputs of the solar DDC 21 and the solar DDC 22 are stopped after securing a path for releasing the overvoltage charge stored in the capacitor 70 connected to the intermediate point by using only the power conversion unit constituted by the high-voltage DDC 30 and the high-voltage battery 50. As a result, all of the solar DDC 21, the solar DDC 22, the high-voltage DDC 30, and the auxiliary DDC 40 can be stopped in a state in which the intermediate point voltage is reduced to a safe level. Thus, the circuit elements and the like in the solar charging system 1 can appropriately be protected from deterioration and failure. The overvoltage charge stored in the capacitor 70 may be released by using only the power conversion unit constituted by the auxiliary DDC 40 and the auxiliary battery 60. The power conversion unit to be used to release the electric charge in the capacitor 70 may dynamically be determined based on, for example, the conditions of the high-voltage battery 50 and the auxiliary battery 60 (power storage amounts, temperatures, ages, and the like).

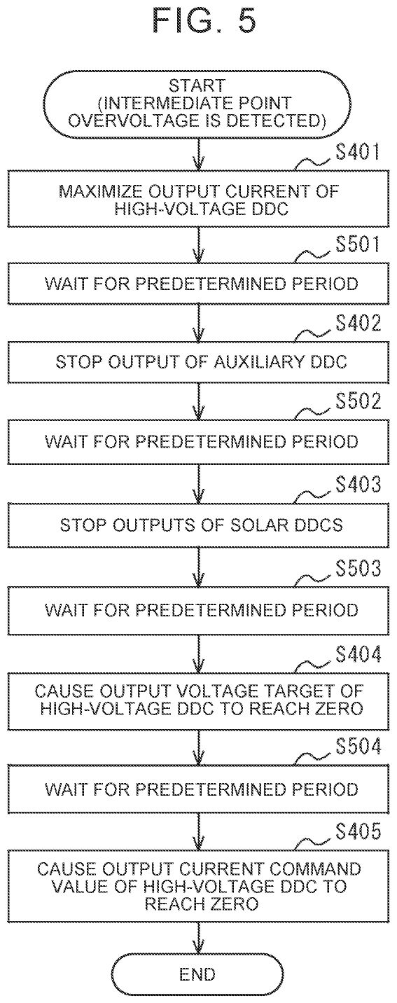

When there is a possibility that the order of the processes from Step S401 to Step S405 is changed due to, for example, the compilation speed of the processing program or the control response of the circuit elements, a predetermined period to wait for execution (Steps S501, S502, S503, and S504) may be provided between the processing steps as shown in an applied example of FIG. 5. Examples of the predetermined waiting period include one cycle of the system clock.

### Actions and Effects

As described above, in the solar control device 100 according to the embodiment of the present disclosure, when the voltage at the intermediate point connecting the solar unit (solar DDC 21 and solar DDC 22) and the power conversion unit (high-voltage DDC 30 and auxiliary DDC 40) is an overvoltage, the output of the solar unit is stopped after establishing the path for releasing the overvoltage charge stored in the capacitor 70 connected to the intermediate point by the power conversion unit.

Through this process, all of the solar DDC 21, the solar DDC 22, the high-voltage DDC 30, and the auxiliary DDC 40 are stopped after the voltage at the intermediate point is reduced to a safe level. Thus, the circuit elements and the like in the solar charging system 1 can appropriately be protected from deterioration and failure.

Although one embodiment of the technology of the present disclosure has been described above, the present disclosure is not limited to the solar control device, and can be understood as, for example, a method to be executed by the solar control device, a program for the method, a non-transitory computer-readable storage medium storing the program, and a vehicle including the solar control device.

The solar control device of the present disclosure can be used in, for example, a vehicle that charges a battery with electric power generated by a solar panel.

What is claimed is:

1. A control device comprising a processor configured to:
detect a voltage at an intermediate point connecting a first DCDC converter and a second DCDC converter;
control the first DCDC converter and the second DCDC converter; and
when the detected voltage at the intermediate point exceeds a first threshold, limit an output of the first DCDC converter after an output current of the second DCDC converter reaches a predetermined value, wherein
the processor is configured to control a charging system including a solar unit and a power conversion unit,
the solar unit includes a solar panel and the first DCDC converter,
the power conversion unit includes the second DCDC converter and a rechargeable battery connected to the second DCDC converter,
electric power generated by the solar panel is configured to be input to the first DCDC converter, and
electric power output by the solar unit is configured to be input to the second DCDC converter.

2. The control device according to claim 1, wherein the charging system includes two solar units as the solar unit, or two power conversion units as the power conversion unit.

3. The control device according to claim 2, wherein the processor is configured to cause the output current of the second DCDC converter to reach a second threshold or smaller after limiting the output of the first DCDC converter.

4. The control device according to claim 2, wherein:
the charging system includes two power conversion units as the power conversion unit; and
the processor is configured to
limit an output of the second DCDC converter included in one of the two power conversion units when the detected voltage at the intermediate point exceeds the first threshold, and
limit the output of the first DCDC converter after the output current of the second DCDC converter included in the other of the two power conversion units reaches the predetermined value.

5. The control device according to claim 2, wherein the predetermined value of the output current of the second DCDC converter is a maximum value.

6. The control device according to claim 2, wherein the processor is configured to limit the output of the first DCDC converter and an output of the second DCDC converter by stopping the outputs.

7. A control method for a control device configured to control a charging system including a solar unit including a solar panel and a first DCDC converter, and a power conversion unit including a second DCDC converter and a rechargeable battery connected to the second DCDC converter, the control method comprising:
detecting a voltage at an intermediate point where the first DCDC converter is connected to the second DCDC converter, electric power generated by the solar panel is configured to be input to the first DCDC converter, and electric power output by the solar unit is configured to be input to the second DCDC converter;
controlling an output current of the second DCDC converter to reach a predetermined value when the detected voltage at the intermediate point exceeds a first threshold; and
limiting an output of the first DCDC converter after the output current of the second DCDC converter is controlled to reach the predetermined value.

8. The control method according to claim 7, wherein the charging system includes two solar units as the solar unit, or two power conversion units as the power conversion unit.

9. A non-transitory storage medium storing instructions that are executable by one or more processors in a computer of a control device and that cause the one or more processors to perform functions, the control device being configured to control a charging system including a solar unit including a solar panel and a first DCDC converter, and a power conversion unit including a second DCDC converter and a rechargeable battery connected to the second DCDC converter, the functions comprising:
detecting a voltage at an intermediate point where the first DCDC converter is connected to the second DCDC converter, electric power generated by the solar panel is configured to be input to the first DCDC converter, electric power output by the solar unit is input to the second DCDC converter;
controlling an output current of the second DCDC converter to reach a predetermined value when the detected voltage at the intermediate point exceeds a first threshold; and
limiting an output of the first DCDC converter after the output current of the second DCDC converter is controlled to reach the predetermined value.

10. The non-transitory storage medium according to claim 9, wherein the charging system includes two solar units as the solar unit, or two power conversion units as the power conversion unit.
